(19) United States
(12) Patent Application Publication
(10) Pub. No.: US 2024/0256911 A1
(43) Pub. Date: Aug. 1, 2024

(54) METHOD AND DEVICE FOR ESTABLISHING WEAK PATTERN SEVERITY MODEL

(71) Applicant: UNITED MICROELECTRONICS CORP., Hsinchu (TW)

(72) Inventors: Yan-Hsiu LIU, Tainan City (TW); Pin-Yen TSAI, Hsinchu City (TW)

(21) Appl. No.: 18/123,531

(22) Filed: Mar. 20, 2023

(30) Foreign Application Priority Data
Jan. 30, 2023 (CN) 202310074591.6

(51) Int. Cl. G06N 5/022; G06F 18/2415

(52) U.S. Cl. CPC G06N 5/022; G06F 18/2415

(57) ABSTRACT

A method and a device for establishing a weak pattern severity model are provided. The method for establishing the weak pattern severity model includes the following steps. A plurality of weak patterns are obtained. A plurality of experiments are performed on each of the weak patterns with a plurality of parameter setting values of at least one process parameter to obtain a plurality of experimental results. According to the experimental results, a plurality of defects are obtained. According to the defects and the corresponding parameter setting values, a severity level of each of the weak patterns is analyzed. The weak patterns are labeled the severity levels. Machine learning is performed to train a weak pattern severity model.

This application claims the benefit of People's Republic of China application Serial No. 202310074591.6, filed Jan. 30, 2023, the disclosure of which is incorporated by reference herein in its entirety.

### TECHNICAL FIELD

The disclosure relates in general to an establishing method and an establishing device, and more particularly to a method and a device for establishing a weak pattern severity model.

### BACKGROUND

With the evolution of semiconductor technology, various semiconductor devices are constantly being introduced. Semiconductor devices require thousands of processes to be successfully manufactured. Once there is a weak pattern in the layout, there may be disconnection, short circuit, etc. in the process or finished product.

In order to improve product yield, researchers must predict the weak pattern of the layout to avoid disconnection, short circuit and other situations.

### SUMMARY

The disclosure is directed to a method and a device for establishing a weak pattern severity model. It uses Design Of Experiment (DOE) technology to plan different parameter setting values for at least one process parameter, so as to repeatedly test a certain weak pattern. According to a plurality of experimental results, a plurality of severity levels of a plurality of weak patterns can be analyzed. With the severity levels of the weak patterns, a weak pattern severity model can be trained. Using the weak pattern severity model to predict the weak pattern has high accuracy, and there is no need to spend a lot of manpower and time for further screening, effectively improving the product yield.

According to one embodiment, a method for establishing a weak pattern severity model is provided. The method for establishing the weak pattern severity model includes the following steps. A plurality of weak patterns are obtained. A plurality of experiments are performed on each of the weak patterns with a plurality of parameter setting values of at least one process parameter to obtain a plurality of experimental results. A plurality of defects are obtained according to the experimental results. A severity level of each of the weak patterns is analyzed according to the defects and the parameter setting values. The severity levels are labeled on the weak patterns. Machine learning is performed to train a weak pattern severity model.

According to another embodiment, a device for establishing a weak pattern severity model is provided. The device for establishing the weak pattern severity model includes a process weakness acquisition unit, an experimental result acquisition unit, a defect analysis unit, a severity analysis unit, a labeling unit and a training unit. The process weakness acquisition unit is configured to obtain a plurality of weak patterns. A plurality of experiments are performed on each of the weak patterns with a plurality of parameter setting values of at least one process parameter to obtain a plurality of experimental results. The experimental result acquisition unit is configured to obtain the experimental results. The defect analysis unit is configured to obtain a plurality of defects according to the experimental results. The severity analysis unit is configured to analyze a severity level of each of the weak patterns according to the defects and the parameter setting values. The labeling unit is configured to label the severity levels on the weak patterns. The training unit is configured to perform machine learning through the weak patterns labeled the severity levels to train a weak pattern severity model.

### BRIEF DESCRIPTION OF THE DRAWINGS

FIG. 1 shows a schematic diagram of a design rule checking procedure according to one embodiment.

FIG. 2 shows a schematic diagram of a predictive classification model according to one embodiment.

FIG. 3 shows a schematic diagram of a weak pattern severity model according to one embodiment.

FIG. 4 shows a block diagram of a device 100 for establishing the weak pattern severity model according to one embodiment.

FIG. 5 shows a flowchart of a method for establishing the weak pattern severity model according to one embodiment.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

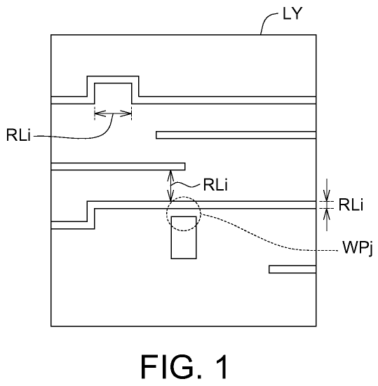

Please refer to FIG. 1, which shows a schematic diagram of a design rule checking procedure according to one embodiment. In one embodiment, each layout LY will be checked according to several predetermined design rules RLi to check out the weak pattern WPj. The design rule checking procedure is, for example, using a computer to automatically check, or relying on manual inspection.

However, if the design rule RLi is too strict, some weak patterns WPj may not be detected. If the design rule RLi is too loose, it may take a lot of manpower and time to screen out the real possible weak pattern WPj.

In addition, many weak patterns WPj are formed due to factors such as the edge light-transmittance, and cannot be screened out by design rule RLi.

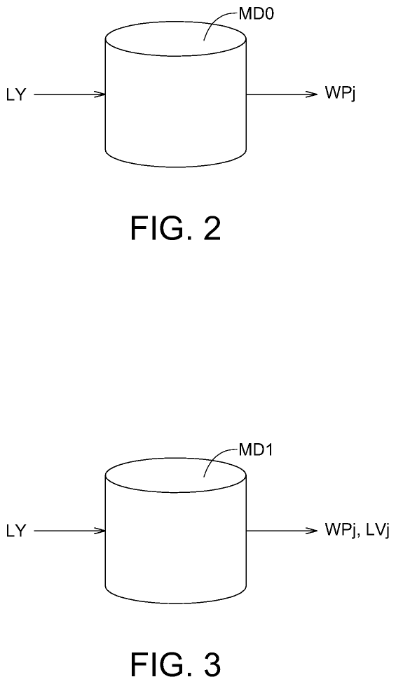

Please refer to FIG. 2, which shows a schematic diagram of a predictive classification model MD0 according to one embodiment. In one embodiment, the predictive classification model MD0 can be trained by using big data. After the training on the predictive classification model MD0 is completed, the layout LY can be input to the predictive classification model MD0 and then whether it contains any weak pattern WPj is outputted. However, this predictive classification model MD0 only uses a binary classifier for classification, which not only has low prediction accuracy, but also has poor training results.

Please refer to FIG. 3, which shows a schematic diagram of a weak pattern severity model MD1 according to one embodiment. In order to improve the prediction accuracy, a weak pattern severity model MD1 is proposed in this disclosure. The layout LY can be input to the weak pattern severity model MD1 to output a severity level LVj of each weak pattern WPj. The severity level LVj refers to the possibility of this weak pattern WPj resulting defects in the process. In other words, the weak pattern severity model MD1 disclosed in this disclosure can not only predict whether the layout LY contains any weak pattern WPj, but also predict the severity level LVj of this weak pattern WPj. Designers can refer to the severity level LVj to adjust the layout LY. For example, when there are multiple weak patterns WPj in a certain layout LY, the designer can give priority to adjusting the weak pattern WPj with a higher severity level, so as to avoid adjusting to weak pattern WPj with a lower severity level, which will instead generate more process problems.

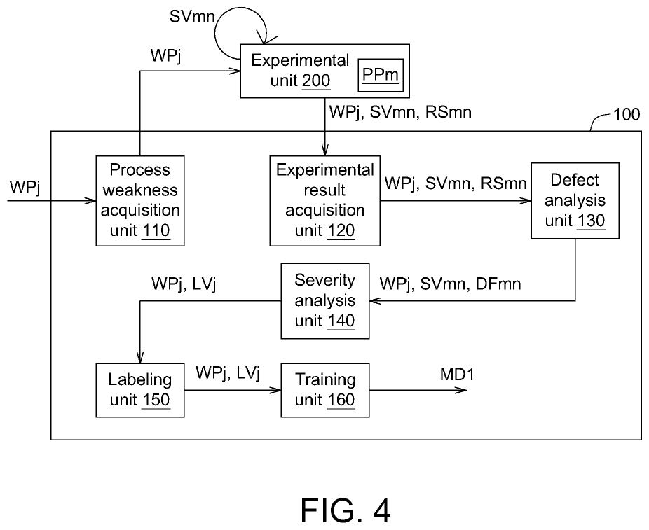

Please refer to FIG. 4, which shows a block diagram of a device 100 for establishing the weak pattern severity model MD1 according to one embodiment. The device 100 includes a process weakness acquisition unit 110, an experimental result acquisition unit 120, a defect analysis unit 130, a severity analysis unit 140, a labeling unit 150 and a training unit 160. The process weakness acquisition unit 110, the experimental result acquisition unit 120, the defect analysis unit 130, the severity analysis unit 140, the labeling unit 150 and the training unit 160 are used to execute various analysis programs, processing programs and control programs, such as a circuit, a chip, a circuit board, a program code, a computer program product, or a storage device for storing program code.

In this embodiment, the device 100 uses Design Of Experiment (DOE) technology to plan different parameter setting values for at least one process parameter, so as to repeatedly test a certain weak pattern WPj. According to the experimental results, the severity level LVj of the weak pattern WPj can be analyzed. With the severity level LVj of the weak pattern WPj, the weak pattern severity model MD1 can be trained. The operation of the above-mentioned components is described in detail below with a flow chart.

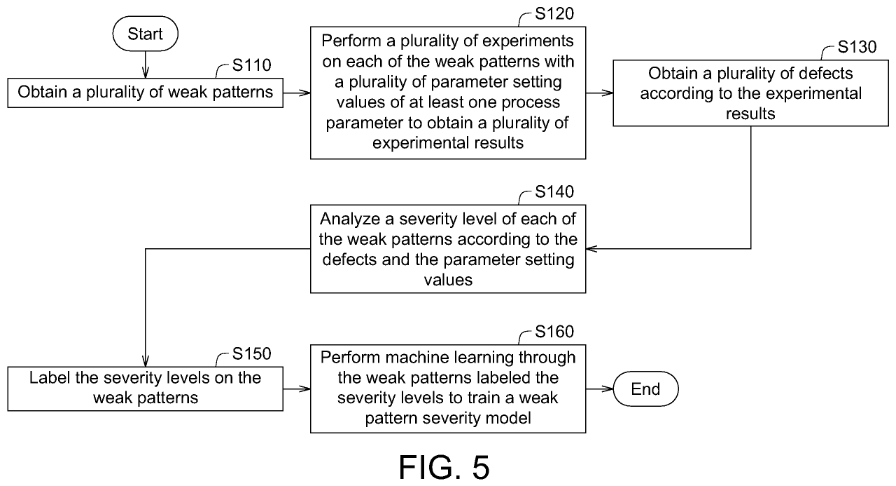

Please refer to FIG. 5, which shows a flowchart of a method for establishing the weak pattern severity model MD1 according to one embodiment. In step S110, the process weakness acquisition unit 110 obtains a plurality of weak patterns WPj. The weak patterns WPj are obtained through the Design rule checking procedure (DRC procedure), for example. Alternatively, the weak patterns WPj are obtained, for example, by the predictive classification model MD0 (shown in FIG. 2). The process weakness acquisition unit 110 can obtain various weak patterns WPj through the design rule checking procedure and the predictive classification model MD0 at the same time.

In one embodiment, in order to conduct a comprehensive severity level analysis on all possible weak patterns WPj, the design rule RLi (shown in FIG. 1) can be relaxed in the design rule checking procedure to obtain more weak patterns WPj.

Next, in step S120, the experimental unit 200 performs a plurality of experiments on each of the weak patterns WPj with a plurality of parameter setting values SVmn of at least one process parameter PPm to obtain a plurality of experimental results RSmn. The process parameter PPm is, for example, the lithography exposure energy of one of the exposure apparatus. The parameter setting values SVmn of the lithography exposure energy cover, for example, from the minimum set value to the maximum set value. For example, several identical weak patterns WPj can be arranged on a wafer, and different parameter setting values SVmn of the lithography exposure energy can be used for each of the weak patterns WPj to obtain different experimental results RSmn.

Or, the process parameter PPm is, for example, the exposure focal length of one of the exposure apparatus. The parameter setting values SVmn of the exposure focal length, for example, cover from the minimum setting value to the maximum setting value. For example, several identical weak patterns WPj can be arranged on a wafer, and different parameter setting values SVmn of the exposure focal length can be used for each of the weak patterns WPj to obtain different experimental results RSmn.

Or, the process parameters PPm are, for example, both of the lithography exposure energy and the exposure focal length of the exposure apparatus. The parameter setting values SVmn of the lithography exposure energy cover, for example, from the minimum set value to the maximum set value. The parameter setting values SVmn of the exposure focal length also cover from the minimum setting value to the maximum setting value. The parameter setting values SVmn of the lithography exposure energy and the parameter setting values SVmn of the exposure focal length form a parameter variation matrix. For example, several identical weak patterns WPj can be arranged on a wafer, and different parameter setting values SVmn of the lithography exposure energy and the exposure focal length can be used for each of the weak patterns WPj to obtain different experimental results RSmn.

After the above various experiments are completed, the experimental results RSmn are obtained by the experimental result acquisition unit 120.

Then, in step S130, the defect analysis sheet 130 obtains a plurality of defects DFmn according to the experimental results RSmn. The defect analysis unit 130, for example, analyzes various defects DFmn by means of optical detection and electrical testing. In the above experimental results RSmn, some of the experimental results RSmn produced defects DFmn, and some of the experimental results did not produce any defect DFmn.

In one embodiment, the defect analysis unit 130 can use a Qual tree algorithm to analyze the data structure, so as to map these defects DFmn and their experimental parameter setting values SVmn to some of the weak patterns WPj. Alternatively, the defect analysis unit 130 can use GeoPandas to perform position overlap analysis, so as to correspond these defects DFmn and their experimental parameter setting values SVmn to some of the weak patterns WPj.

After corresponding these defects DFmn and their experimental parameter setting values SVmn to some of the weak patterns WPj, it can be found that some weak patterns WPj will produce the defects DFmn only at extreme parameter setting values SVmn; some weak patterns WPj will produce defects DFmn near the middle parameter setting values SVmn will generate defects DFmn. If one defect DFmn is generated when the parameter setting value SVmn close to the middle is used in the experiment, it means that this weak pattern WPj is very likely to cause many problems in the online process or product.

In addition, some weak patterns WPj will generate defects DFmn only in a small range composed of a few parameter setting values SVmn; some weak patterns WPj will generate defects DFmn in a large range composed of many parameter setting values SVmn. If defect DFmn is generated in most parameter setting values SVmn during the experiment, it means that this weak pattern WPj is very likely to cause many problems in the online process or product.

Next, in step S140, the severity analysis unit 140 analyzes the severity level of each of the weak patterns WPj according to the defects DFmn and the corresponding parameter setting values SVmn. For example, the severity analysis unit 140 gives a severity level LVj to each of the weak patterns WPj. The severity analysis unit 140 can set the severity level LVj to be inversely proportional to the deviation degree of the parameter setting value SVmn. If a defect DFmn is generated by using a parameter setting value SVmn close to the middle during the experiment, it means that this weak pattern WPj is very likely to cause many problems in the online process or product, so the severity analysis unit 140 can give it a higher severity level LVj.

Or, in another embodiment, the severity analysis unit 140 can set the severity level LVj to be proportional to the quantity (or range size) of the parameter setting values SVmn. If some defects DFmn are generated in most parameter setting values SVmn during the experiment, it means that this weak pattern WPj is very likely to cause many problems in the online process or product, so the severity analysis unit 140 can give it a higher severity level LVj.

Then, in step S150, the labeling unit 150 labels the severity levels LVj on the weak patterns WPj. If a weak pattern WPj does not correspond to any defect DFmn, the labeling unit 150 will still label it with the lowest severity level LVj.

Then, in step S160, the training unit 160 performs machine learning through the weak pattern WPj labeled the severity levels LVj to train the weak pattern severity model MD1.

According to the above various embodiments, it uses the Design Of Experiment (DOE) technology to plan different parameter setting values SVmn for at least one process parameter PPm, so as to repeatedly test a certain weak pattern WPj. According to the experimental results RSmn, the severity levels LVj of the weak patterns WPj can be analyzed. With the severity levels LVj of the weak patterns WPj, the weak pattern severity model MD1 can be trained. Using the weak pattern severity model MD1 to predict the weak pattern WPj has high accuracy, and there is no need to spend a lot of manpower and time for further screening, effectively improving the product yield.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A method for establishing a weak pattern severity model, comprising:
obtaining a plurality of weak patterns;
performing a plurality of experiments on each of the weak patterns with a plurality of parameter setting values of at least one process parameter to obtain a plurality of experimental results;
obtaining a plurality of defects according to the experimental results;
analyzing a severity level of each of the weak patterns according to the defects and the parameter setting values;
labeling the severity levels on the weak patterns; and
performing machine learning to train a weak pattern severity model.

2. The method for establishing the weak pattern severity model according to claim 1, wherein the severity levels are inversely proportional to deviation degrees of the parameter setting values.

3. The method for establishing the weak pattern severity model according to claim 1, wherein the weak patterns are obtained through a design rule checker.

4. The method for establishing the weak pattern severity model according to claim 1, wherein the weak patterns are obtained by a predictive classification model.

5. The method for establishing the weak pattern severity model according to claim 1, wherein the defects are corresponded to some of the weak patterns through a quadtree algorithm.

6. The method for establishing the weak pattern severity model according to claim 1, wherein the at least one process parameter is a lithography exposure energy.

7. The method for establishing the weak pattern severity model according to claim 1, wherein the at least one process parameter is an exposure focal length.

8. The method for establishing the weak pattern severity model according to claim 1, wherein the at least one process parameter includes a lithography exposure energy and an exposure focal length, the parameter setting values of the lithography exposure energy and the parameter setting values of the exposure focal length form a parameter variation matrix.

9. A device for establishing a weak pattern severity model, comprising:
a process weakness acquisition unit, configured to obtain a plurality of weak patterns, wherein a plurality of experiments are performed on each of the weak patterns with a plurality of parameter setting values of at least one process parameter to obtain a plurality of experimental results;
an experimental result acquisition unit, configured to obtain the experimental results;
a defect analysis unit, configured to obtain a plurality of defects according to the experimental results;
a severity analysis unit, configured to analyze a severity level of each of the weak patterns according to the defects and the parameter setting values;
a labeling unit, configured to label the severity levels on the weak patterns; and
a training unit, configured to perform machine learning through the weak patterns labeled the severity levels to train a weak pattern severity model.

10. The device for establishing the weak pattern severity model according to claim 9, wherein the severity levels are inversely proportional to deviation degrees of the parameter setting values.

11. The device for establishing the weak pattern severity model according to claim 9, wherein the weak patterns are obtained through a design rule checker.

12. The device for establishing the weak pattern severity model according to claim 9, wherein the weak patterns are obtained by a predictive classification model.

13. The device for establishing the weak pattern severity model according to claim 9, wherein the defects are corresponded to some of the weak patterns through a quadtree algorithm.

14. The device for establishing the weak pattern severity model according to claim 9, wherein the at least one process parameter is a lithography exposure energy.

15. The device for establishing the weak pattern severity model according to claim 9, wherein the at least one process parameter is an exposure focal length.

16. The device for establishing the weak pattern severity model according to claim 9, wherein the at least one process parameter includes a lithography exposure energy and an exposure focal length, the parameter setting values of the lithography exposure energy and the parameter setting values of the exposure focal length form a parameter variation matrix.
